(19) United States
(12) Patent Application Publication
(10) Pub. No.: US 2011/0073543 A1
(43) Pub. Date: Mar. 31, 2011

(54) SYSTEM AND METHOD FOR USING UREA AS A NITROGEN SOURCE IN A BIOREACTOR

(75) Inventor: Lee Shafer, Big Piney, WY (US)

(73) Assignee: ANTICLINE DISPOSAL, LLC, Boulder, WY (US)

(21) Appl. No.: 12/872,419

(22) Filed: Aug. 31, 2010

Related U.S. Application Data
(60) Provisional application No. 61/246,438, filed on Sep. 28, 2009.

(51) Int. Cl. C02F 3/12

(52) U.S. Cl. 210/610; 210/96.1

(57) ABSTRACT

The disclosure describes systems and methods for utilizing urea in a bioreactor as a source of nitrogen.

### RELATED APPLICATIONS

This application claims the benefit of U.S. Provisional Application No. 61/246,438, filed Sep. 28, 2009, and entitled, “System and Method for Using Urea as a Nitrogen Source in a Bioreactor”, which application is hereby incorporated herein by reference.

### INTRODUCTION

A bioreactor aerates biodegradable waste generated by humans, other animals, and/or industrial process wastes with waste-degrading microorganisms (or activated sludge). Nitrogen is an important nutrient for the microorganisms that provide the treatment in a bioreactor. Accordingly, the bioreactor requires a source for nitrogen to function properly.

Water, especially in the western United States and other arid regions, is a valuable resource. Many oil and natural gas production operations generate, in addition to the desired hydrocarbon products, large quantities of waste water, referred to as “produced water”. Produced water is a type of industrial process waste and may be cleaned with a bioreactor. Produced water is typically contaminated with significant concentrations of chemicals and substances requiring that it be disposed of or treated before it can be reused or discharged to the environment.

### SUMMARY

This disclosure describes systems and methods for utilizing urea in a bioreactor as a source of nitrogen.

In part, this disclosure describes a wastewater system for biologically treating wastewater. The wastewater system for biologically treating wastewater includes a bioreaction vessel, a urea addition system that adds urea to the bioreaction vessel, and a nickel addition system that adds nickel to the bioreaction vessel based on the conversion of urea into ammonia in the bioreaction vessel.

Another aspect of this disclosure describes a nickel-enhanced urea product for use in treatment systems. The nickel-enhanced urea product includes an amount of urea, and an effective amount of nickel to convert the amount of urea to ammonia in a bioreaction vessel to provide an effective amount of biologically-available forms of nitrogen.

Yet another aspect of this disclosure describes a method for using urea as a nitrogen source in a bioreactor. The method includes adding an amount of nickel effective to convert urea to ammonia in a bioreaction vessel.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The following drawing figures, which form a part of this application, are illustrative of embodiment systems and methods described below and are not meant to limit the scope of the disclosure in any manner, which scope shall be based on the claims appended hereto.

FIG. 1 illustrates an embodiment of a bioreactor treatment system.

FIG. 2 illustrates an embodiment of a method for biologically treating waste water deficient in nickel using urea as a source of nitrogen.

FIG. 3 illustrates a table of data generated from an example embodiment of adjusting nickel concentrations in a bioreactor in which urea is used as the nitrogen source.

FIG. 4 illustrates a graphical representation of MLSS, urea added, and nickel sulfate added from the example embodiment shown in FIG. 3.

FIG. 5 illustrates a graphical representation of MLSS and wasting from the example embodiment shown in FIG. 3.

FIG. 6 illustrates a graphical representation of feed nitrogen, permeate nitrogen, urea added, and nitrogen sulfate added from the example embodiment shown in FIG. 3.

### DETAILED DESCRIPTION

Before the urea systems are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken as quantitatively or source limiting, reference to “a step” may include multiple steps, reference to “producing” or “products” of a reaction should not be taken to be all of the products of a reaction, and reference to “reacting” may include reference to one or more of such reaction steps. As such, the step of reacting can include multiple or repeated reaction of similar materials to produce identified reaction products.

This disclosure describes systems and methods for utilizing urea in a bioreactor as a source of nitrogen. Nitrogen is an important nutrient for the microorganisms that provide the treatment in a bioreactor. Typically, ammonia (NH₃) is used as the nitrogen source, often added to a bioreactor as ammonium hydroxide or anhydrous ammonia in order to maintain some predetermined operating condition such as a target nitrogen concentration or a target microorganism density. However, ammonia can be expensive to use both due to the cost of the ammonia itself and the equipment necessary to handle the ammonia safely. Urea ((NH₂)₂CO) is another source of nitrogen that is also available. Being solid, colorless, odorless, neither acidic nor basic, highly soluble in water, and relatively non-toxic, urea is widely used in fertilizers as a convenient source of nitrogen.

Through experimentation in substituting urea for ammonia in the biological treatment of industrial wastewater, specifically oilfield wastewaters commonly referred to as “produced water”, it has been determined that nickel, at least in trace amounts, improves the conversion of urea into a form of nitrogen usable by the microorganisms treating the wastewater. It appears that this need for nickel in biotreatment of water has not been identified until now as most sanitary and industrial wastewater commonly treated today contains sufficient nickel for the conversion to occur without the need for human intervention. Without being bound to any particular theory, it is believed that the absence of nickel inhibits the creation of urease enzyme by microorganisms, which subsequently limits the rate of urea nitrogen conversion to useable form, such as ammonia, and that that in the absence of urease, urea may be inefficiently utilized as some of it may be converted to nitrate which is not an effective nitrogen nutrient source for aerobic bacteria.

The systems and methods, described herein relate to a bioreactor treating water having a concentration of nickel so low as to inhibit the conversion of added urea to ammonia or other biologically-available forms of nitrogen. In an embodiment a nickel content of less than 0.02 milligrams/liter nickel (0.02 mg/l Ni) is presumed to be so low as to prevent conversion of added urea when urea is used as the nitrogen source for the microorganisms. When nickel sulfate (NiSO₄) is used as the source of nickel, this corresponds to adding 0.05 mg/l nickel sulfate to the wastewater before treatment.

One difficulty in determining the appropriate level of nickel to provide in order to convert urea is that it appears the nickel level is well below the detection limit of commonly used nickel analyses. For example, the nickel analyses most commonly used have a detection limit of 0.5 mg/l, well above the treatment levels identified herein. As nickel detection technology improves it may someday be cost-effective to measure nickel concentrations directly. However, with the currently-available wet chemistry normally used in the field, for now it is easier to confirm that the urea is or is not being converted and subsequently utilized by the microorganism population by monitoring total nitrogen, ammonia nitrogen, and nitrate in the bioreactor or its effluent than to measure nickel directly.

With this in mind, in one embodiment of the nickel addition system and method, nickel sulfate may be added to the bioreactor in an amount sufficient to observe an increase in urea conversion. This may be indicated by an increase in ammonia (e.g., a detection of ammonia as that would indicate a conversion of urea into ammonia in excess of the amount usable by the current microbial population) in the effluent. This recognizes the heretofore unknown effect that, absent nickel, a bioreactor operating on urea (and not ammonia) would not convert all the urea to usable nitrogen. Urea concentration, total nitrogen, and/or nitrate in the effluent of the reactor may also be monitored to determine the extent to which urea is being converted.

Alternative treatment criteria may also be used to determine the appropriate level of nickel in the bioreactor such as criteria based on a drop in biological oxygen demand, total organic carbon or turbidity. Nickel treatment may also be determined based on reactor operating conditions such as the microorganism population (e.g., mass per volume), or some measure of the amount of urease enzyme in the reactor.

The amount of nickel added may be contingent upon the nature of the water being treated, as some water may have some small amount of nickel below the detection limits of current wet chemistry, yet not have enough nickel to support the complete conversion of the amount of urea necessary to support the desired microorganism population. In such a situation, it is believed the most cost-effective method of finding the right amount of nickel to add is to gradually increase/decrease the amount of nickel until the performance of the bioreactor is improved or maximized.

It should further be noted that any soluble compound of nickel may be utilized as long as the compound does not introduce anions that interfere with the operation of the bioreactor or other treatment equipment or goals. Nickel sulfate is described herein as the nickel source but nickel chloride (NiCl₂), nickel nitrate (Ni(NO₃)₂) and other nickel compounds may also promote the same conversion of urea observed with nickel sulfate. In yet another embodiment, the nickel may be added by directly adding urease enzyme, such as in the form of jack bean meal, although this may be a more costly approach to achieve the same performance levels than adding nickel compounds.

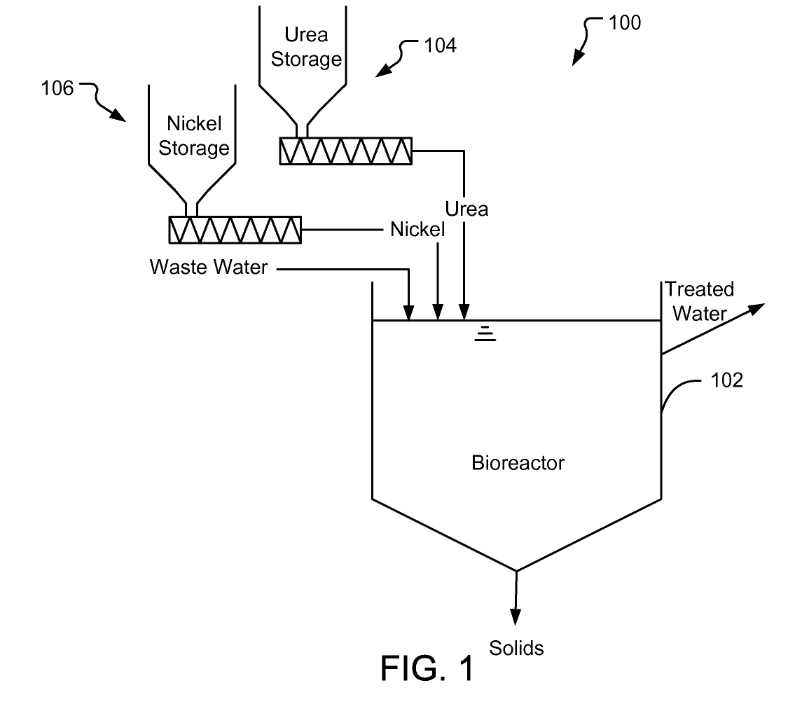

FIG. 1 illustrates an embodiment of a bioreactor system 100. The bioreactor system includes a bioreactor 102 that may take any suitable form or design including a simple open or closed vessel as well as any purpose-built bioreactors now known or later developed. Examples of suitable bioreactors 102 include tray bioreactors, stirred-tank bioreactors, concentric draught-tube bioreactors, membrane bioreactors, airlift external-loop reactors, trickle-bed bioreactors, packed-bed bioreactors, and fluidized-bed bioreactors to name only a few possible types.

In addition, bioreactor system 100 may or may not include ancillary equipment such as stirrers, flow control or impedance devices, oxygen, air or other gas diffusers and solids removal systems. The bioreactor system 100 may also include one or more vessels of the same or differing designs connected in series or in parallel and may be operated as a batch or continuous process. Further, the bioreactor system 100 may be externally heated or cooled depending on the ambient environment and the nature of the contaminants being treated.

System 100 illustrated in FIG. 1, further includes a urea delivery system 104 capable of delivering a continuous or periodic amount of urea to the bioreactor 102 or into the influent stream prior to entry into the bioreactor 102. Similarly, the system further includes a nickel delivery system 106 capable of delivering a continuous or periodic amount of nickel (such as in the form of nickel sulfate) to the bioreactor 102 or into the influent stream prior to entry into the bioreactor 102. In another embodiment, not shown, a combined nickel and urea dosing system could be used in which a combined product comprising a nickel compound and urea is delivered to the wastewater stream by a single delivery system.

In the embodiment illustrated, the delivery systems 104 and 106 are solids delivery systems that include a storage vessel and a screw conveyor. Many different solids delivery systems are known in the art and any suitable delivery system may be used. Alternatively, if the urea and/or nickel compound used are liquid, a suitable liquid delivery device may be used. Delivery equipment may be automated or manually operated. In yet another embodiment, the urea and/or nickel compound may be manually measured and delivered by hand on a periodic (e.g., daily) basis.

In an embodiment, an initial population of selected microorganisms may be provided to the bioreactor system 100 during a startup operation. Alternatively, a naturally occurring population may be fostered during startup of the system 100.

In the embodiment shown, water deficient in nickel, but otherwise containing contaminants to be treated by digestion, is input to the bioreactor system 100. Urea is provided as a second input as a supplemental source of nitrogen to provide nutrients for the population of microorganisms in the bioreactor 102. Nickel is added, such as in the form of nickel sulfate, as a third input to the bioreactor 102. Other inputs are also possible such as additional nutrients or process chemicals such as for pH adjustment.

A monitoring system may or may not be provided to control the amount of nickel added during operation. As discussed above, many different parameters may be monitored to determine the appropriate amount of nickel to add to the bioreactor 102. In an embodiment, ammonia concentration in the bioreactor 102 is monitored by a suitable device and nickel is added in an amount sufficient to convert the urea into a detectable level of ammonia. Other parameters in the influent or effluent that may be monitored include the concentration of nickel, microorganism mass, ammonia, nitrate, total nitrogen, total organic carbon, urea, urease enzyme, biological oxygen demand, chemical oxygen demand or any other parameter directly or indirectly indicative of the health of the microorganism population or the conversion of urea into different forms of nitrogen.

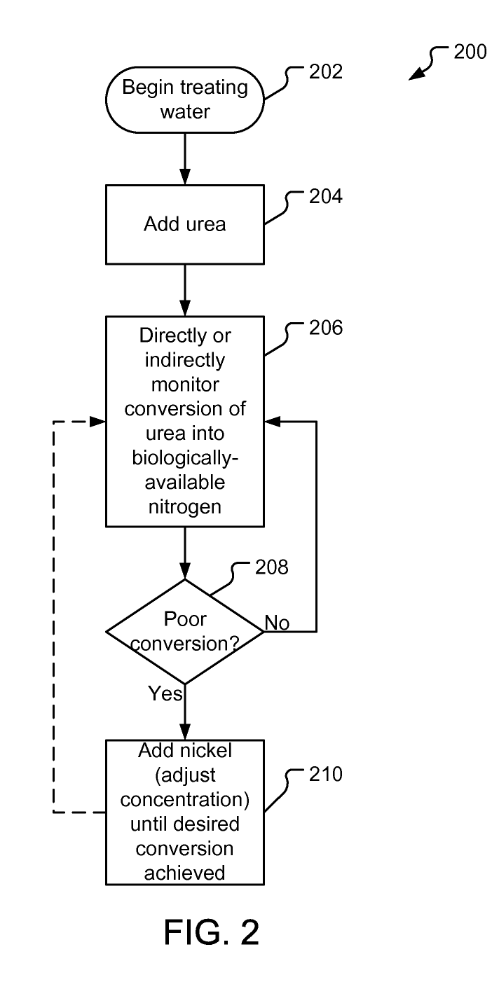

FIG. 2 illustrates an embodiment of a method for biologically treating wastewater deficient in nickel using urea as a source of nitrogen 200. In the embodiment shown, method 200 starts with treating water in a begin treatment operation 202. The water may be any type of wastewater and it may or may not be known whether the nickel content is so low as to limit the conversion of urea. In the method 200, the treatment includes a biological treatment process which may be aerobic or anaerobic digestion in which the maintenance of a healthy population of microorganisms is a necessary part of the treatment.

As part of the treatment, urea is added to be a source of nitrogen for the microorganisms in a urea addition operation 204. The urea may be the only form of additional nitrogen added or may be used in combination with other sources of nitrogen such as ammonia. In yet another embodiment, depending on the relative cost of urea and ammonia, the system may alternate between using urea as a nitrogen source and using other nitrogen sources. The amount of urea added may be based on empirical analyses or may be based on calculations estimated based on desired concentrations and loading.

The treatment system then monitors for direct or indirect evidence that urea is being converted into biologically-available forms of nitrogen. This is illustrated in the monitoring operation 206. It should be understood that it is presumed that urea is not directly being converted by the nickel, but rather as an indirect result of increasing the nickel concentration in the wastewater. However, for the purposes of this description the reader will understand that the conversion of urea ultimately results from the addition of nickel and therefore nickel is referred as causing the conversion of the urea. As discussed in greater detail above, any suitable parameters or criteria may be monitored that directly or indirectly allow the determination of whether the urea is being converted into usable forms of nitrogen.

As illustrated by the determination operation 208, if the monitoring operation 206 indicates that there is insufficient conversion of urea, a nickel adjustment operation 210 may be performed. If the monitoring operation 206 indicates that the urea is sufficiently converted, determination operation 208 returns to the monitoring operation 206. This may occur in situations in which the initial amount nickel in the waste water is unknown (or it is below detection limits), but nevertheless is of sufficiently high concentration as to convert the urea.

In an embodiment, the nickel adjustment operation 210 may include slowly increasing the rate at which nickel is added and monitoring the effect of the addition in order to determine the appropriate dosing level. For example, an initial nickel dosing level of 0.001 g/l Ni may be selected and then increased periodically such as by 0.001 g/l increments until adequate urea conversion is confirmed by the monitoring operation 206. In an alternative embodiment, an initial nickel dosing level based on the volume of water to be treated may be selected, such as 0.01 g/l Ni and the amount may be gradually decreased until evidence is observed of poor urea conversion. In yet another embodiment, the initial dosing level may be determined based on pilot or bench testing.

Yet another aspect of this disclosure is a nickel-enhanced urea product for use in treatment systems as a nitrogen source. This eliminates the need for the installation and operation of a separate nickel addition system. In an embodiment of the nickel-enhanced urea, nickel sulfate, or other nickel-containing salts may be mixed with or provided in the same container as urea. The combination product may be used in exactly the same manner as urea with the additional nickel ensuring adequate conversion even in the event that the wastewater does not contain the necessary nickel for conversion of the urea.

Such a product may contain from 0.0038 to 38 grams Ni/pound of urea (corresponding to 0.01 to 100 g nickel sulfate/pound of urea as nickel sulfate is 38% by weight nickel), or more preferably from 0.038 to 3.8 grams Ni/pound of urea (0.1 to 10 g nickel sulfate/pound urea) or more preferably still from 0.15 to 0.75 grams Ni/pound of urea (0.5 to 2 g nickel sulfate/pound urea).

### EXAMPLES

### Example 1

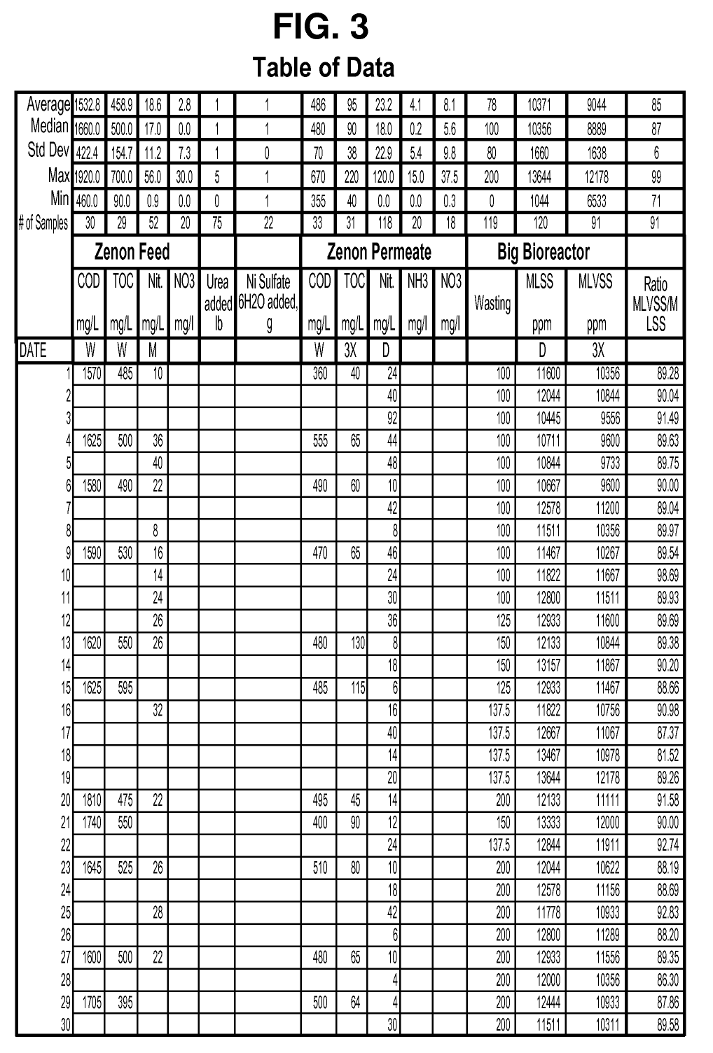

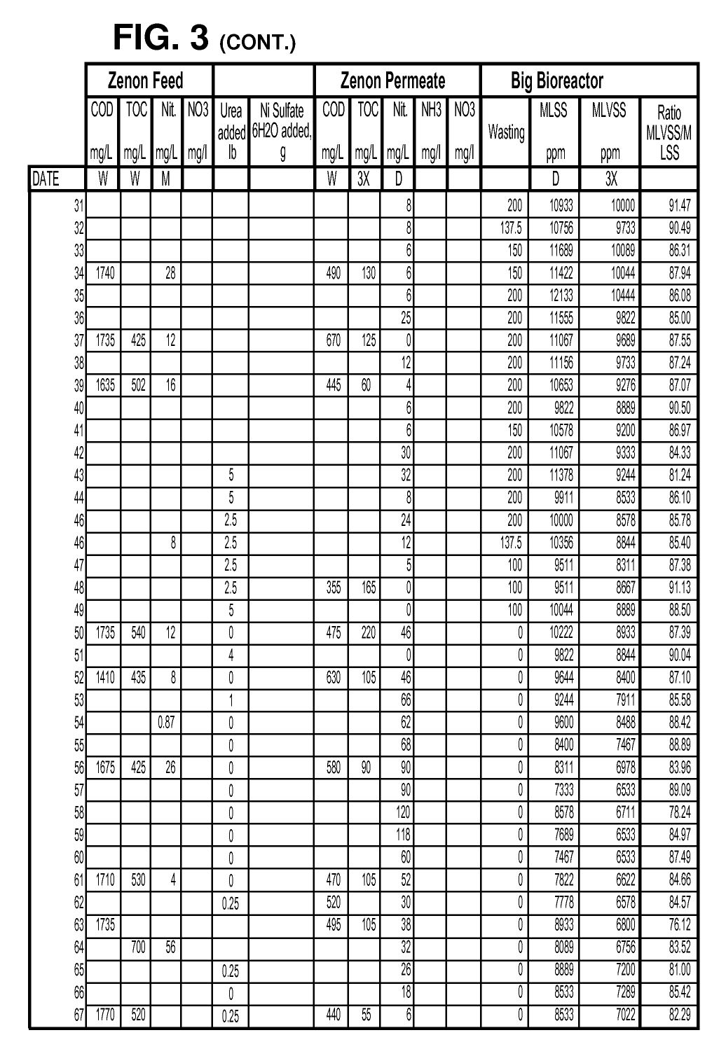

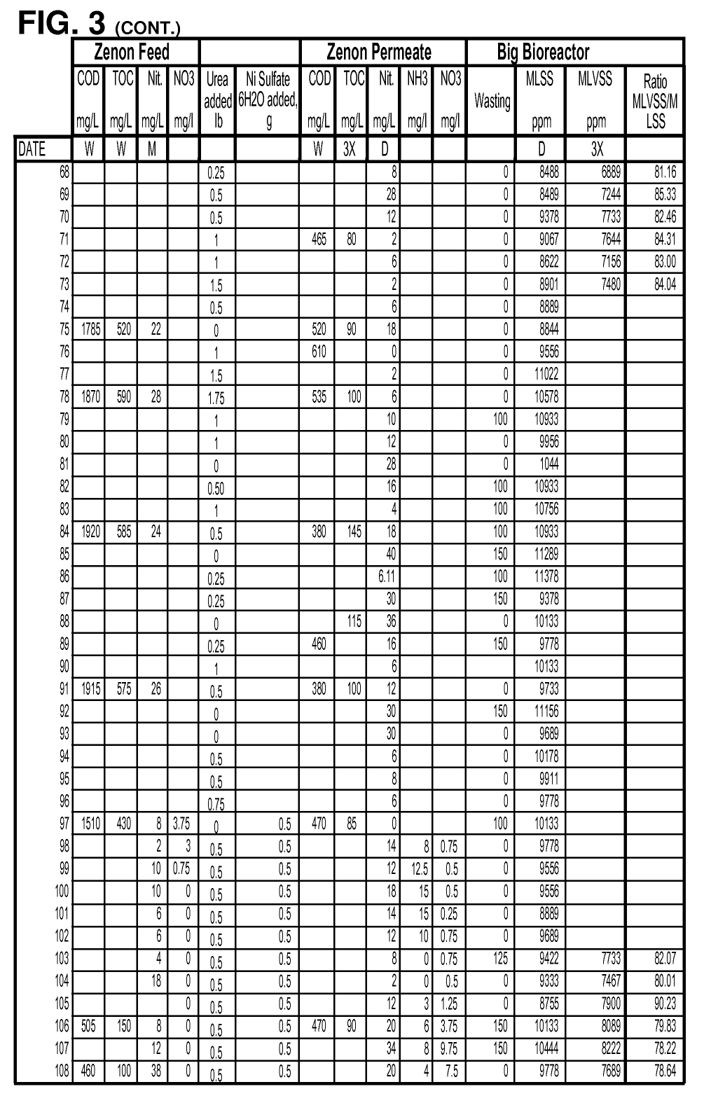

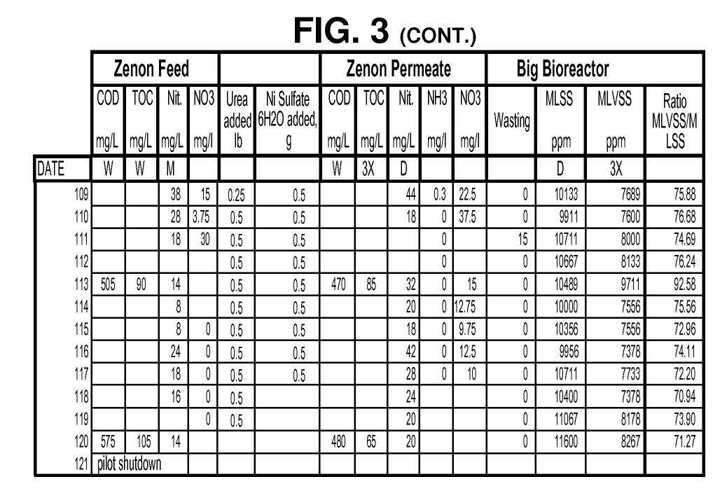

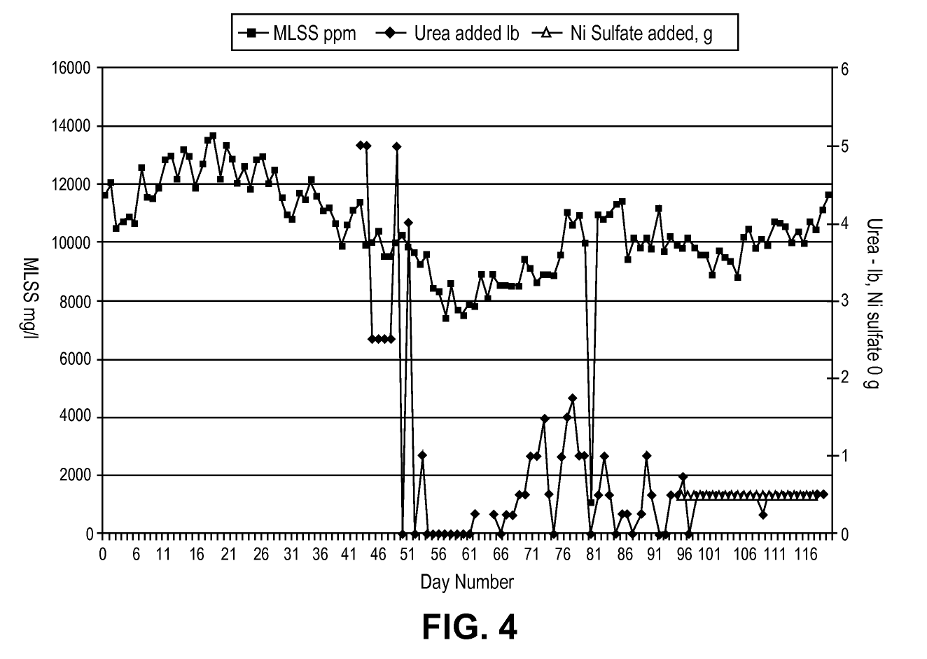

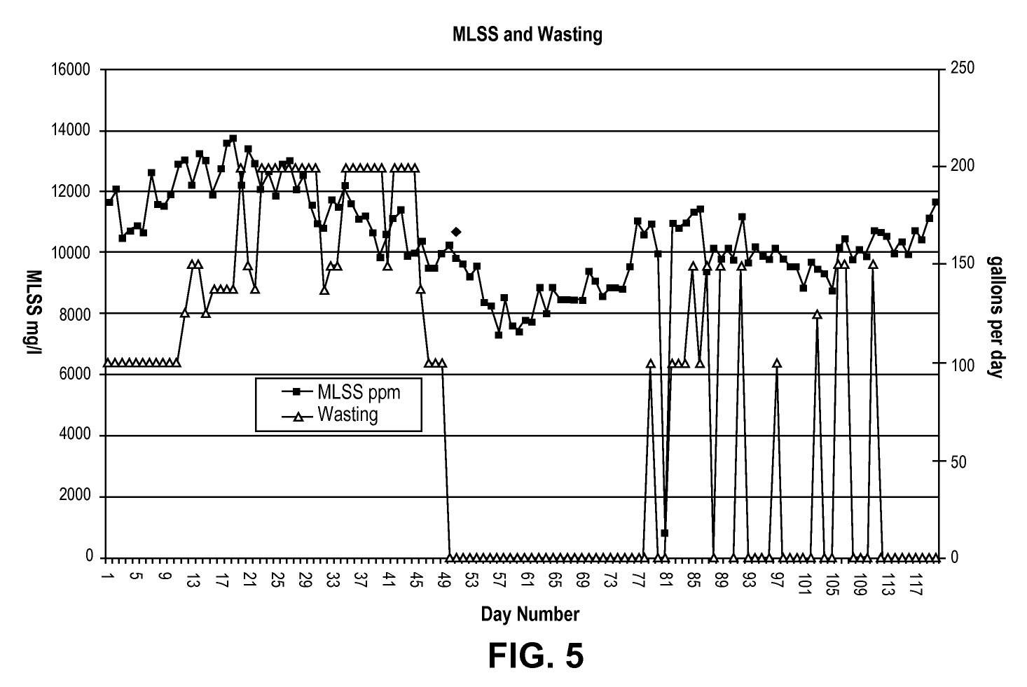

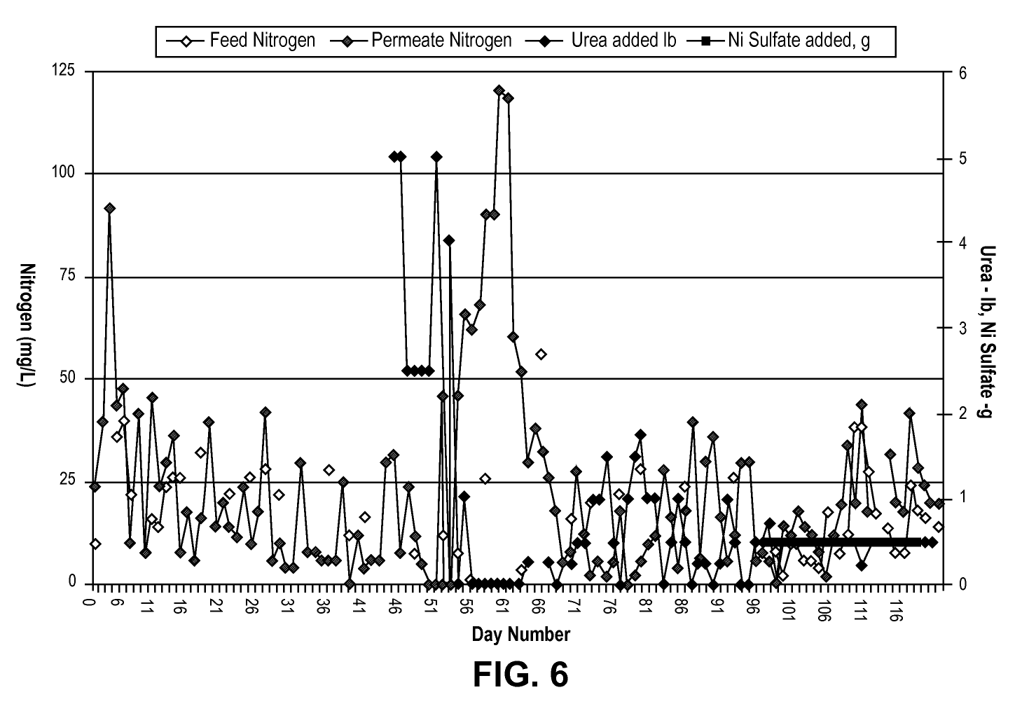

The use of urea as a substitute for ammonia was investigated in a bioreactor during the ongoing treatment of produced water by a treatment system. The treatment system included a membrane bioreactor manufactured by Zenon owned by GE Water & Process Technologies, headquartered at 4636 Somerton Road, Trevose, Pa., 19053-6783. During the operation, various parameters of the influent and effluent of the bioreactor were monitored from Day 1 to Day 120. The influent was monitored just prior to the bioreactor and the effluent was monitored after an additional filtering operation. Starting on Day 1, the system was stable and operated using ammonia as the nitrogen source. On Day 43, the ammonia addition was replaced with a urea addition as the nitrogen source. After determining that the urea was not being converted sufficiently, on Day 97 the addition of 0.5 grams of nickel sulfate per day was begun. The table illustrated in FIG. 3 lists the data obtained from monitoring the influent and effluent of the bioreactor from Day 1 to Day 120. After Day 120 the bioreactor treatment system was shutdown. FIG. 4 illustrates a graph of MLSS by ppm, Urea added by pound, and Nickel sulfate added by gram from Day 1 to Day 120 taken from the table shown in FIG. 3. FIG. 5 illustrates a graph of MLSS by ppm and Wasting by gallons per day from Day 1 to Day 120 taken from the table shown in FIG. 3. FIG. 6 illustrates a graph of Feed Nitrogen by mg/L, Urea added by pound, Permeate Nitrogen per mg/L, and Nickel sulfate added by gram from Day 1 to Day 120 taken from the table shown in FIG. 3.

This data indicates that microorganism production dropped off after the switch to urea, which is shown in the graph in FIG. 5. The system stopped wasting bacteria altogether for several weeks at day 50. Initially, large amounts of urea were added, which yielded excess nitrogen, but not enough usable nitrogen for the microorganism population. On day 54, no urea was added as the system appeared to the operators to be overdosed with total nitrogen. Finally, on day 62 the system was stabilized with lower doses of urea and then improved with addition of nickel on day 97. In fact, during the first few days of nickel addition, significant ammonia was found in the effluent (identified as “permeate nitrogen” in FIG. 6) until the microorganism population recovered to the extent that the population could consume all of the biologically-available nitrogen.

As part of the treatment, residual nickel was not analyzed as it was already known that the produced water being treated had an initial concentration of nickel below the detection limit of 0.5 mg/l. However, during treatment, nitrogen consumption and specifically ammonia in the effluent downstream from the bioreactor were monitored, which are Considered a good indicator of urea conversion to ammonia. For instance, FIG. 6 illustrates feed nitrogen and nitrogen residual with urea addition and nickel sulfate addition on the secondary y axis. As the nickel was added, the nitrogen comes under control with the urea getting utilized and effluent (i.e., membrane bioreactor permeate) nitrogen nearly equal to what was in the feed. A significant part of the residual nitrogen that is not getting utilized is excess that has been converted to nitrate, which the aerobic bacteria do not utilize.

Without being held to any particular theory, the addition of nickel is inferred to allow the production of urease which converted the urea. Further, the urea requirement was significantly less than projected and it appears that nearly all the urea was converted and used. While the required nickel concentration is unknown, the pilot unit responded to 0.5 g nickel sulfate per day in approximately 2.5 gpm continuous wastewater feed and permeate rate, which is roughly 0.01 mg/l as Nickel.

### Example 2

Prior to adding the nickel in Example 1, a bench test was also performed to determine if the lack of urease could be the source of the poor performance when urea was used instead of ammonia. The following are the results of the bench tests using “jack bean meal” as the source of urease.

Test 1:
1-liter of distilled water, 2 grams urea, and 0.14 grams of jack bean meal were combined.
At 2 hours, a definite scent of ammonia was detected. Also, an ammonia test at 350 mg/l (using a 50× dilution) was performed.
At 4 hours, a very strong scent of ammonia was detected. Again, an ammonia test at 500 mg/l (using a 50× dilution) was performed.

Test 2:
1-liter of pilot biology, 2 grams urea, and 0.19 grams of jack bean meal were combined.
At 2 hours, a faint scent of ammonia was detected. An ammonia test at 100 mg/l (using a 25× dilution) was performed.
At 4 hours, a definite scent of ammonia was detected. Again, an ammonia test at 250 mg/l (using a 25× dilution) was performed.

Previous bench tests (that is, tests performed prior to the above Test 1 and Test 2), which did not use urease, yielded no ammonia from the urea. The concentration of urease/nickel in the jack bean meal was not known; however, it is known that jack bean meal is recognized as a common natural source of urease.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents, which may otherwise be afforded a particular value. Further, unless otherwise stated, the term “about” shall expressly include “exactly,” consistent with the discussions regarding ranges and numerical data. Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 4 percent to about 7 percent” should be interpreted to include not only the explicitly recited values of about 4 percent to about 7 percent, but also include individual values and sub-ranges within the indicated range. Thus, included in this numerical range are individual values such as 4.5, 5.25 and 6 and sub-ranges such as from 4-5, from 5-7, and from 5.5-6.5; etc. This same principle applies to ranges reciting only one numerical value. Furthermore, such an interpretation should apply regardless of the breadth of the range or the characteristics being described.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope of the present invention. For example, different forms of soluble nickel could be used instead of those specifically listed herein and the nickel may be added at any point in the wastewater stream prior to the entry into the bioreactor. In addition, because only trace amounts of nickel are necessary (far below the level of environmental interest and regulation), the methods described above could intentionally overdose the water to be treated with nickel in order to ensure performance without any attempt to optimize the nickel dosing level. Numerous other changes may be made which will readily suggest themselves to those skilled in the art and which are encompassed in the spirit of the disclosure.

What is claimed is:

1. A wastewater system for biologically treating wastewater comprising:
a bioreaction vessel;
a urea addition system that adds urea to the bioreaction vessel; and
a nickel addition system that adds nickel to the bioreaction vessel based on the conversion of urea into ammonia in the bioreaction vessel.

2. The wastewater system of claim 1, further comprising:
a monitoring system that determines the appropriate amount of nickel to add to the bioreaction vessel.

3. The wastewater system of claim 1, wherein the urea addition system comprises a storage vessel and a screw conveyor.

4. The wastewater system of claim 1, further comprising an ammonia monitoring system that provides information indicative of a concentration of ammonia in the bioreaction vessel to the nickel addition system.

5. The wastewater system of claim 1, wherein the nickel addition system and the urea addition system are separate components of a combined nickel and urea dosing system that adds a nickel-enhanced urea product to the bioreaction vessel.

6. The wastewater system of claim 1, further comprising:
a measuring system that measures the amount of biologically-available forms of nitrogen in the bioreaction vessel.

7. A method for using urea as a nitrogen source in a bioreactor comprising:
adding an amount of nickel effective to convert urea to ammonia in a bioreaction vessel.

8. The method of claim 7, further comprising:
adding urea to a bioreaction vessel.

9. The method of claim 8, further comprising:
monitoring for evidence that the urea added to the bioreaction vessel is being converted into biologically-available forms of nitrogen.

10. The method of claim 9, wherein the evidence is the concentration of ammonia in the bioreaction vessel.

11. The method of claim 10, wherein the evidence further comprises at least one of nickel concentrations, microorganism mass, nitrate concentrations, total nitrogen concentrations, total organic carbon concentrations, urea concentrations, and biological oxygen demand in the bioreaction vessel.

12. The method of claim 7, further comprising:
determining that an insufficient amount of urea is being converted into biologically-available forms of nitrogen in the bioreaction vessel.

13. A nickel-enhanced urea product for use in treatment systems comprising:
an amount of urea; and
an effective amount of nickel to convert the amount of urea to ammonia in a bioreaction vessel to provide an effective amount of biologically-available forms of nitrogen.

14. The nickel-enhanced urea product of claim 11, wherein the effective amount of nickel is from 0.0038 to 38 grams of nickel per pound of urea.

15. The nickel-enhanced urea product of claim 11, wherein the effective amount of nickel is from 0.038 to 3.8 grams of nickel per pound of urea.

16. The nickel-enhanced urea product of claim 11, wherein the effective amount of nickel is from 0.15 to 0.75 grams of nickel per pound of urea.

17. A wastewater system for biologically treating wastewater comprising:
a bioreaction vessel;
at least one monitoring device that monitors a parameter directly or indirectly indicative of the health of the microorganism population contained in the wasterwater treated by the bioreaction vessel;
a urea addition system that adds urea to the bioreaction vessel; and
a nickel addition system that adds nickel to the bioreaction vessel based on the monitored parameter.

18. The wastewater system of claim 17, wherein the monitored parameter is selected from a parameter indicative of a concentration of ammonia, a concentration of nickel, microorganism mass, a concentration of nitrate, a concentration of total nitrogen, a concentration of total organic carbon, a concentration of urea, a concentration of urease enzyme, a concentration of biological oxygen demand, and a concentration of chemical oxygen demand.
